(19) United States
(12) Patent Application Publication
(10) Pub. No.: US 2019/0114281 A1
(43) Pub. Date: Apr. 18, 2019

(54) CONVEYING EARLY HINT INFORMATION FOR PHYSICAL LINK STATE CHANGES

(71) Applicant: Intel Corporation, Santa Clara, CA (US)

(72) Inventors: Ang Li, Coquitlam (CA); Kuan Hua Tan, Coquitlam (CA)

(21) Appl. No.: 16/219,922

(22) Filed: Dec. 13, 2018

(51) Int. Cl. G06F 13/40; G06F 13/42

(52) U.S. Cl. CPC G06F 13/4027; G06F 2213/0026; G06F 13/4282

(57) ABSTRACT

Systems, methods, and device can involve an application layer logic implemented at least partially in hardware circuitry; a first port for transmitting information across a multi-lane link, the first port comprising a protocol stack; a memory element, the memory element comprising mapping between an event identifier value and an event identifier carrier value, the event identifier identifying an event to be carried out by the application layer logic across the multi-lane link, the event identifier carrier value mapped to the event identifier, the application layer logic to transmit the event identifier carrier value across the link prior to executing the event.

### BACKGROUND

Interconnects can be used to provide communication between different devices within a system, some type of interconnect mechanism is used. One typical communication protocol for communications interconnects between devices in a computer system is a Peripheral Component Interconnect Express (PCI Express™ (PCIe™)) communication protocol. This communication protocol is one example of a load/store input/output (I/O) interconnect system. The communication between the devices is typically performed serially according to this protocol at very high speeds.

Devices can be connected across various numbers of data links, each data link including a plurality of data lanes. Upstream devices and downstream devices undergo link training upon initialization to optimize data transmissions across the various links and lanes.

### BRIEF DESCRIPTION OF THE DRAWINGS

FIG. 1 illustrates an embodiment of a block diagram for a computing system including a multicore processor.

FIG. 2 is a schematic diagram a comping system that includes devices that include hint content addressable memory (HCAM) in accordance with embodiments of the present disclosure.

FIG. 3 is a schematic diagram illustrating the use of hints to alert an agent to an impending transaction event in accordance with embodiments of the present disclosure.

FIG. 4 is a swim lane diagram illustrating a process flow for the use of hints to an impending transaction event in accordance with embodiments of the present disclosure.

FIG. 5 is a schematic diagram illustrating a connected system implementing early hints for in-band transactions in accordance with embodiments of the present disclosure.

FIG. 6 is a swim lane diagram illustrating a process flow for the use of hints for peer-to-peer in-band transactions in accordance with embodiments of the present disclosure.

FIG. 7 is a schematic diagram illustrating the use of hints for out-of-band transactions in accordance with embodiments of the present disclosure.

FIG. 8 is a swim lane diagram illustrating the use of hints for out-of-band transactions in accordance with embodiments of the present disclosure.

FIG. 9 illustrates an embodiment of a computing system including an interconnect architecture.

FIG. 10 illustrates an embodiment of a interconnect architecture including a layered stack.

FIG. 11 illustrates an embodiment of a request or packet to be generated or received within an interconnect architecture.

FIG. 12 illustrates an embodiment of a transmitter and receiver pair for an interconnect architecture.

FIG. 13 illustrates another embodiment of a block diagram for a computing system including a processor.

FIG. 14 illustrates an embodiment of a block for a computing system including multiple processor sockets.

FIG. 15 is a schematic diagram illustrating a Link Training and Status State Machine for Recovery in accordance with embodiments of the present disclosure.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it is a singular purpose of most fabrics to provide highest possible performance with maximum power saving. Below, a number of interconnects are discussed, which would potentially benefit from aspects of the disclosure described herein.

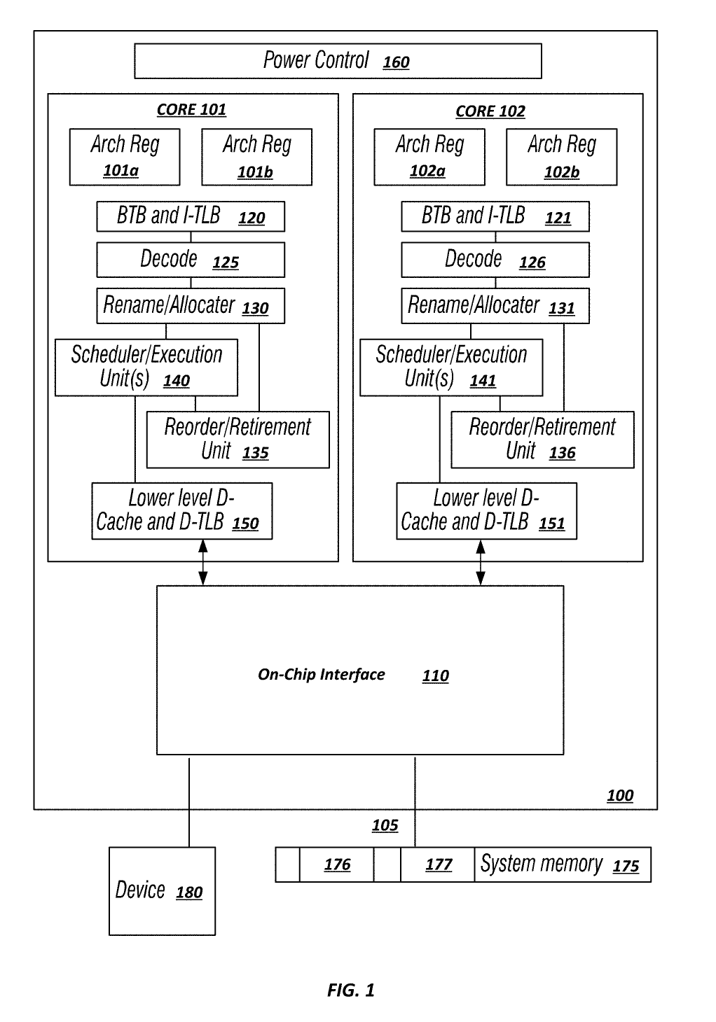

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

In a computing system interconnected by a PCIe hierarchy, the majority of communication between devices depends on the readiness of the PCIe transaction layer to pass Transaction Layer Packets (TLPs) through the hierarchy. On one hand, the application layer agents (on top of the PCIe stack) can generate and consume most of the TLPs. On the other hand, however, when a PCIe link is in a power-saving link state (for example L1 state or L1 substates), even if a certain application layer agent intends to convey information via that link, the information (carried by transaction layer packets (TLPs)) will not be conveyed until the link transits to active L0 state.

Therefore, two problems emerge across the system:

1) Depending on transaction layer of PCIe stack using TLP(s), it is inefficient in term of latency for the computing system that the agent initiating the activity has to wait for the L0-state establishment to be able to pass some meaningful information regarding the intention of the activity;

2) During the link-wake-up-to-L0 period, the application layer agents in other devices receiving the link wake-up notice (usually via TS1/TS2 Ordered Set) do not know a priori what the upcoming task is. TS1 and TS2 Ordered Sets are training sequences used for initializing bit alignment, symbol alignment, and to exchange physical layer parameters. The L0 states is a normal operating state where data and control packets can be transmitted and received. The L1 state (and various substates) generally is intended as a power savings state, in which the PCIe link is in electrical idle (EI) from the device perspective at both the TX and RX sides. Exiting L1 to L0 involves TS1/TS2 transmission and reception (including link training). The PCIe specification provides more details on transitioning from the L1-L0 states (and vice versa).

Due to the lack of system-level hints, those agents will have to make themselves ready to handle all possible tasks that could be received upon PCIe L0 state entry in order to conform to system-level latency/performance requirements. This uncertainy results in unnecessary activity within certain agent(s) or function(s), such as powering up storage media resource, waking up other devices or initiating extra system requests.

As a result, the whole system has to allocate extra power or latency budget for use cases that the system could have handled faster and/or more power-efficiently, were there a way to convey system hints prior to PCIe link readiness.

A simple example is: If one System Image (SI) needs to access a specific virtual function N in a light-sleeping SSD (link in L1), during the link-wake-up-to-L0 period, the SSD have to wake up all its functions for performance requirement due to lack of knowledge that only resources associated with function N is needed and all the rest (like unrelated media die) could have been still kept in light-sleep mode to save more power.

This disclosure describes an architecture for breaking the dependency upon “PCIe transaction layer” readiness to convey system hints between devices. With this architecture, various In-band and Out-of-band methods can be employed to improve system efficiency in terms of latency, power, and performance.

The systems, devices, and techniques described herein provide various in-band (for example, N_FTS) and out-of-band mechanisms to convey information comprehended by application layer functions/entities during PCIe link training period(which is inevitable to bring the PCIe link to active L0 link state). Upon receiving the early hint information during link training, without having to wait for readiness of PCIe transaction layer, those application layer function entities can start their precise preparation of the necessary actions, such as specific sub-block power state transition or necessary system requests initiation.

The systems, devices, and techniques described herein provide various options for communicating early hints between application layer entities connected by PCIe link to process upcoming tasks with both lower latency and more power-efficiency. The systems, devices, and techniques described herein can prevent certain devices from unnecessarily waking up function blocks (for example NAND/3D-Xpoint media dies) that will not be used for the upcoming tasks based on the early hints. With the systems, devices, and techniques described herein, only the respective application layers of related SoC and device need to comprehend the hint, and it can be compliant to PCIe specification.

Aspects of the embodiments are directed to creating or using one or more channels between application layer agents of devices coupled together across a link (such as a PCIe link) for the transmission of hints that can be passed early between the components during the link-wake-up-to-L0 period needed for TLP transfer. There are various ways to create channels, and the channels can be classified as In-band mechanism and Out-of-band mechanism. The devices can include a hint engine (HTE) that can includes or access a hint content addressable memory (HCAM).

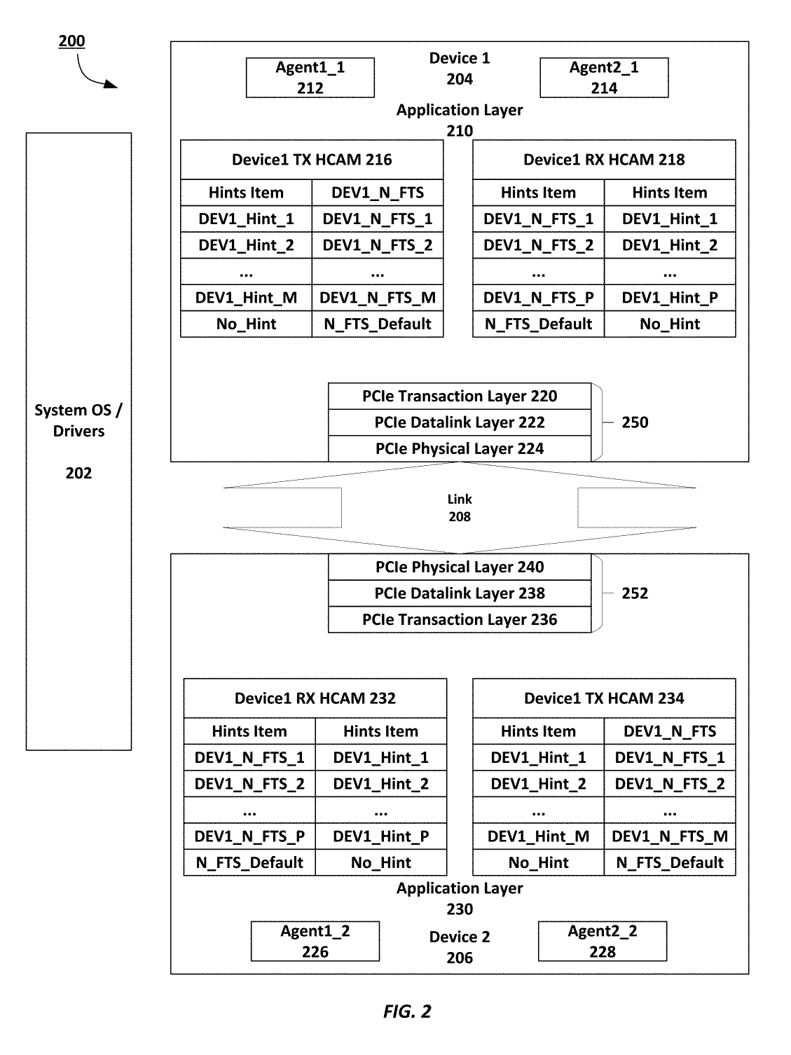

FIG. 2 is a schematic diagram a comping system 20 that includes devices that include hint content addressable memory (HCAM) in accordance with embodiments of the present disclosure. The system 200 includes a system operating system (OS)/drivers 202. The system OS/drivers 202 can provide system-wide operational functionality and instructions as described above. The system 200 can also include a first device Device1 204 coupled to a second device Device2 206 by a link 208. Device1 204 can be an upstream device, such as a host processing system that can include one or more processing cores, memory, as well as other components. Device2 206 can be a downstream device, such as an accelerator, or peripheral device. The link 208 can be a multi-lane link, such as a link based on the PCIe protocol. Device1 204 and Device2 206 can also be compliant with an interconnect protocol, such as that based on the PCIe protocol.

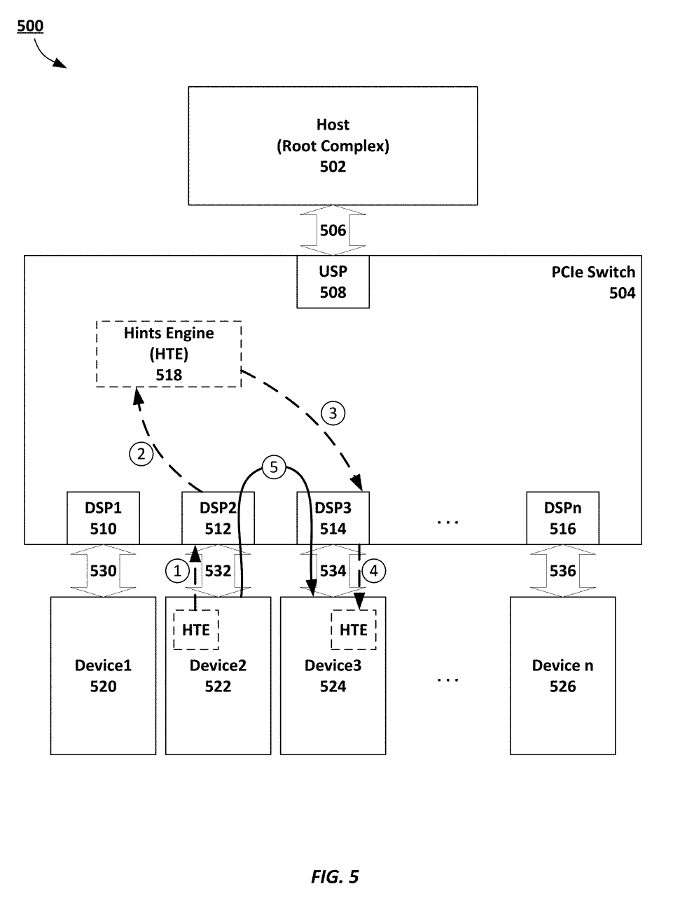

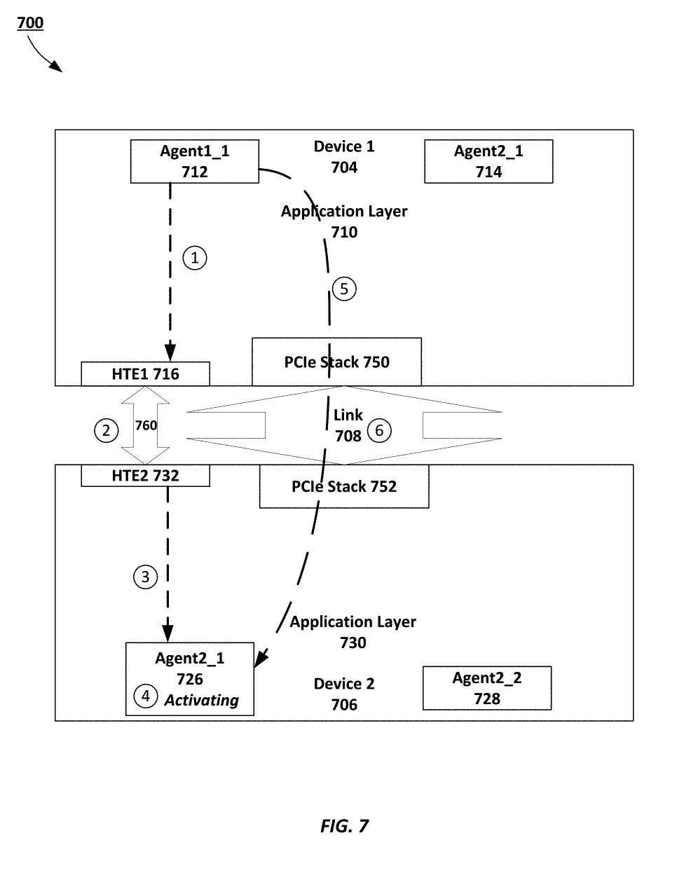

Device1 204 can include Agent1_1 212 and Agent2_1. Similarly, Device2 includes Agent1_2 226 and Agent2_2 228. The agents can be responsible for triggering various events, such as data transmission across the link 208 between Device1 and Device2. Device 1 204 can also include a Device 1 TX hint context-addressable memory (HCAM) 216 and a Device 1 RX HCAM 218. Similarly, Device 2 206 can also include a Device 2 RX HCAM 232 and a Device 2 TX HCAM 234. In FIGS. 5 and 7, the HCAM is embodied in a hint engine (HTE).

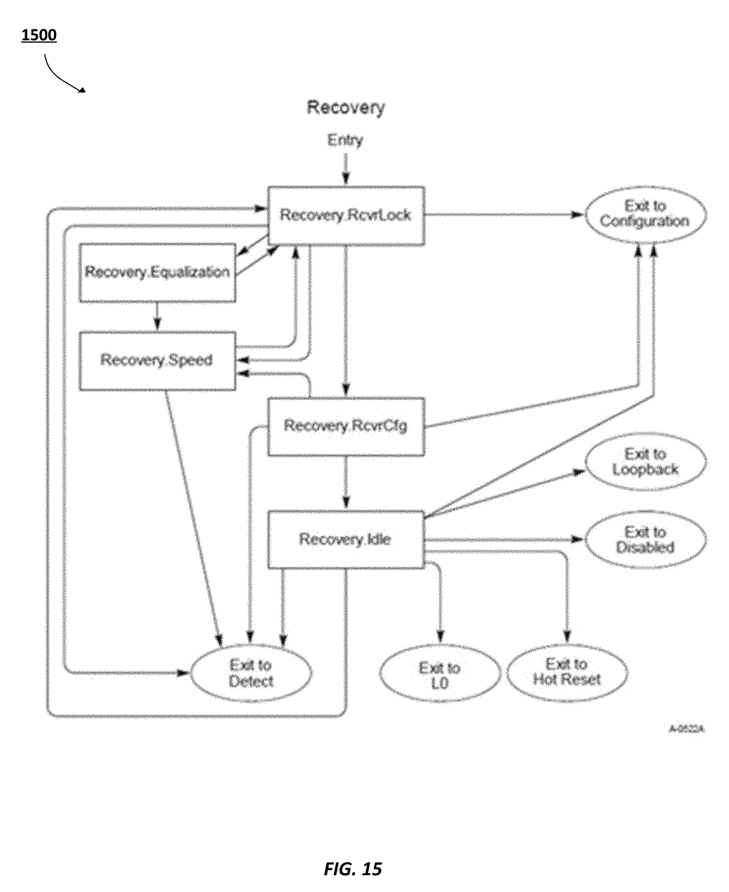

In FIG. 2, each of the PCIe devices Device 1 204 and Device 2 206 has one HCAM for the TX path and another HCAM for RX path implemented at application layer 210, 230, respectively. Each entry of the TX HCAM is used to map one hint (hint item: e.g., DEV1_Hint_M) to a specific N_FTS value (hint carrier: e.g., DEV1_N_FTS_M), which is to be used for TS1 Order Sets in PCIe Link Training and Status State Machine (LTSSM) Recovery.RcvrLock substate during Link training to enter L0 state (see FIG. 15). The RX HCAM is used to extract the hint based on the received N_FTS value in received TS1 Order Sets. Fast training sequence (FTS) is the mechanism that is used for bit and symbol lock when transitioning from a standby state (e.g., L0s) to a normal operating state (e.g., L0). The FTS is used by the receiver to detect the exit from electrical idle and align the receiver's bit/symbol receive circuitry to the incoming data. The PCIe N_FTS definition is provided in Table 2 below.

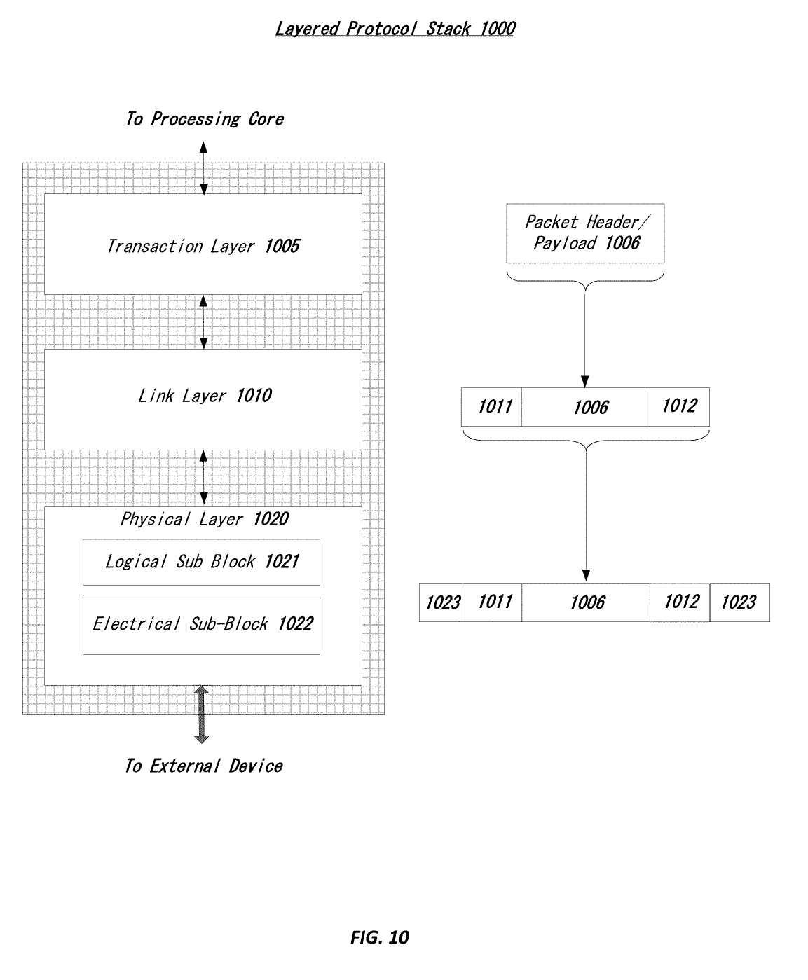

Device 1 204 and Device 2 206 can each also include a PCIe protocol stack 250 and 252, respectively. The PCIe protocol stack 250 can include a PCIe Transaction Layer 220, a PCIe Datalink Layer 222, and a PCIe Physical Layer 224. The PCIe protocol stack 252 can likewise include a PCIe Transaction Layer 236, a PCIe Datalink Layer 238, and a PCIe Physical Layer 240. The various functionalities of each protocol stack layer is described in more detail in the text accompanying FIG. 10, and elsewhere in this disclosure.

Although the discussion herein and the corresponding figures are made in relation to a PCIe stack, the same concepts may be applied to other interconnect stacks.

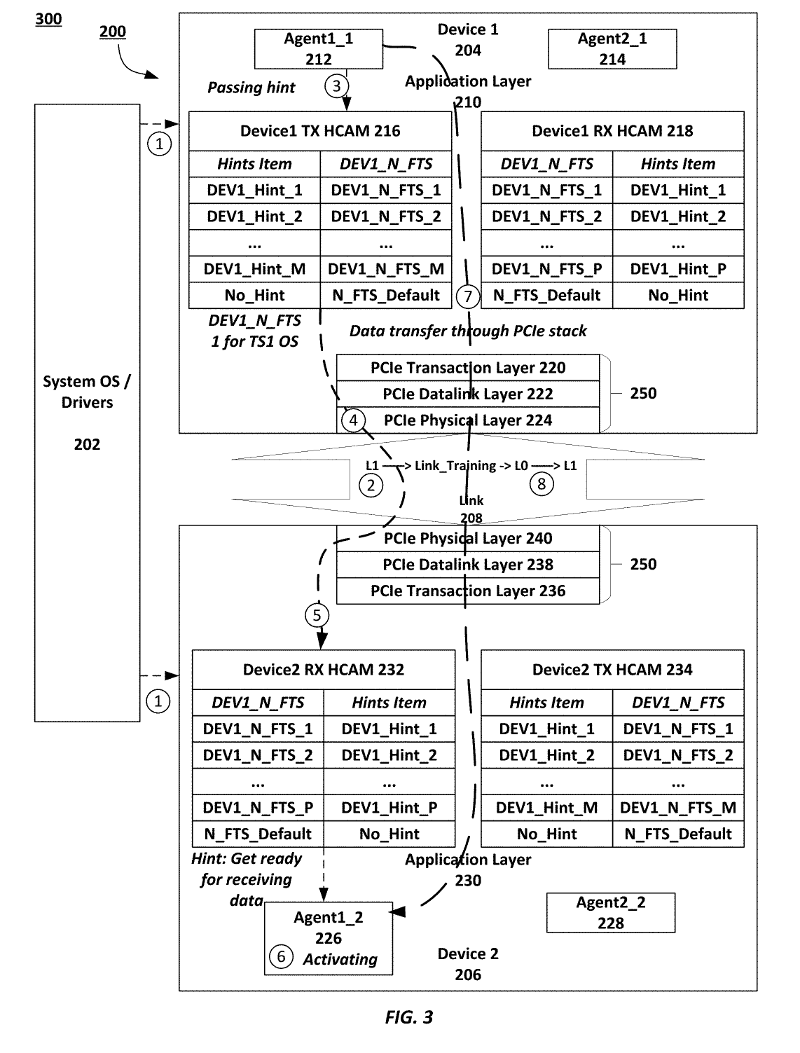

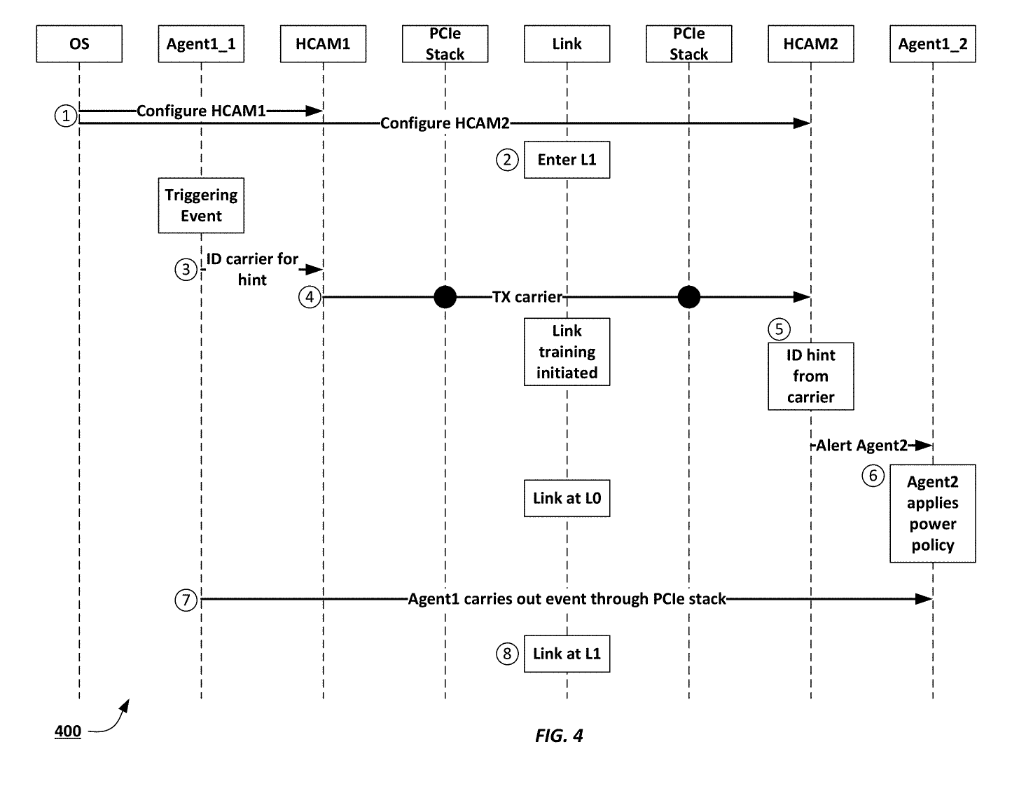

FIG. 3 is a schematic diagram 300 illustrating the use of hints to alert an agent to an impending transaction event in accordance with embodiments of the present disclosure. FIG. 4 is a swim lane diagram illustrating a process flow for the use of hints to an impending transaction event in accordance with embodiments of the present disclosure. FIGS. 3 and 4 are described together to illustrate the transmission flows within the context of an example system structure.

(1) Upon system boot-up, system OS/driver 202 can configure the TX/RX HCAMs 216, 218, 232, and 234 to setup the mapping of hints items with carriers (in this case, the hints items are mapped against DEV1_N_FTS). This initial configuration is optional, since the HCAMs do not have to be configurable if there is no need to dynamically change the hint-and-N_FTS mapping. That is, the HCAMs can be preconfigured and used statically.

(2) For one or more reasons (such as a device entering active state power management (ASPM)), the link 208 is settled in L1 state. ASPM is an autonomous hardware-based active state mechanism that enables power savings even when the connected components are in the DO state. After a period of idle link time, an ASPM physical layer protocol can place the idle link into a lower power state. Once in the lower-power state, transitions to the fully operative L0 state are triggered by traffic appearing on either side of the link, including TS1/TS2 OS.

(3) As an example, Agent1_1 212 decides to pass some data to Agent1_2 226. Based on the transaction type (or triggering event), a corresponding hint (e.g., DEV1_Hint_1) associated to the event is identified and used to search and find the mapping to a corresponding hint carrier (e.g., DEV1_N_FTS_1). The DEV1_Hint_1 could mean “get Device2 Agent1_2 ready for receiving data.”

(4) The carrier is transmitted across link 208 via the PCIe stack 250. Link training is initiated by Device1 PCIe physical layer 224 using DEV1_N_FTS1 during TS1 Order Sets sending phase (LTSSM Recovery.RcvrLock substate) to pass the early hint.

5) Device2 PCIe stack 252 physical layer 240 receives the DEV1_N_FTS_1 hint carrier from the received TS1 OS. The hint carrier can be decoded to retrieve the corresponding hint (DEV1_Hint_1) from RX HCAM 232.

6) Device2 206 applies necessary power policy change or related datapath wake-up to get Agent1_2 226 (and associated resource) actively prepared to receive data from Agent1_1 212.

Between (4) and (6) or after (6), the link L0 state may be reached based on the link training initiated by the transmission of the TS1 OS.

(7) Agent1_1 212 can transmit data across link 208 (in L0 state) to Agent1_2 226 of Device2 206 (e.g., via transaction layer packets (TLPs)).

(8) After (though not necessarily immediately after) data is properly passed and processed by Agent1_2 226, the link 208 may return to L1 again for saving power.

One reason to use DEV1_N_FTS_1 for TS1 OS phase in Recovery.RcvrLock substate is that during TS2 OS sending phase (Recovery.RcvrCfg substate), Device1 204 can switch to send the default N_FTS value, so its N_FTS requirement for L0s feature is not impacted.

During the whole process, Agent2_2 228 can be kept in a low power state. Without the mechanism, during link training, Agent2_2 may have to be activated in order to process possible tasks in a timely manner due to lack of the early hint. The early hint allows for additional power saving by keeping Agent2_2 (and other unused agents) in lower power modes.

As shown in FIGS. 2 and 3, other similar sets of hints can be defined and implemented, such as those in TX HCAM 234 for Device2 to pass early hints to during Recovery.RcvrLock substate. The In-band hints structure, however, does not have to be symmetric between devices. For example, an Endpoint could be the receiver of the hints, and a Host root complex (RC) could be the sender of the hints within the system.

If Device2 206 has a bridge function, the process can be further more efficient in some use cases, such as peer-to-peer scenarios described below.

If there is no hint associated to certain activity, the Device1 204 can choose to use “N_FTS _default” value for TS1 OS sending. This is also compliant to PCIe specification. The N_FTS _Default value can still trigger a change in power state at the indented recipient agent, while also triggering link training from L1→L0 without waking up other agents.

In another example, a device can settled down in ASPM L1 state (link is in L1 state), and the host decides to put the device into D3hot to save more system power. If the host and device implement an early hint mechanism, when the link is woken up from L1 to L0 by TS1/TS2 OS, the host can send a specific N_FTS value to convey the hint to device that “D3hot state will be configured” before the Host can issue the CfgWr to power management and control status (PMCS) register, which occurs after the Link is in L0 state. The Device, therefor, does not need to wake up more application layer entities upon seeing link training, and can start D3hot related tasks earlier than after receiving the CfgWr TLP. Otherwise, without the disclosed early hints mechanism, usually, a device exiting ASPM L1 will have to get all of its function features fully activated in order to serve whatever possible requests it receives from the Host.

FIG. 5 is a schematic diagram illustrating a connected system 500 implementing early hints for in-band transactions in accordance with embodiments of the present disclosure. System 500 can includes a host 502 that can include a root complex or other switching complex. The host 502 can be coupled to a PCIe switch 504 across a link 506 by an upstream port (USP) 508. The PCIe switch 504 can include an implementation of an HTE 518. HTE 518 can include an TX HCAM and RX HCAM as described above in FIGS. 2-3.

The PCIe switch 504 can also include a plurality of downstream ports, such as DSP1 510, DSP2, 512, DSP3 514, . . . and DSPn 516. The PCIe switch 504 can connect devices to the host 502 or to other devices. For example, Device1 520 can be connected to PCIe switch 504 across link 530 by DSP1 510. For example, Device2 522 can be connected to PCIe switch 504 across link 532 by DSP1 512. For example, Device3 524 can be connected to PCIe switch 504 across link 534 by DSP1 514. For example, Device_n 526 can be connected to PCIe switch 504 across link 536 by DSP1 516. Each device can include an HTE that can include one or both of a TX HCAM and an RX HCAM.

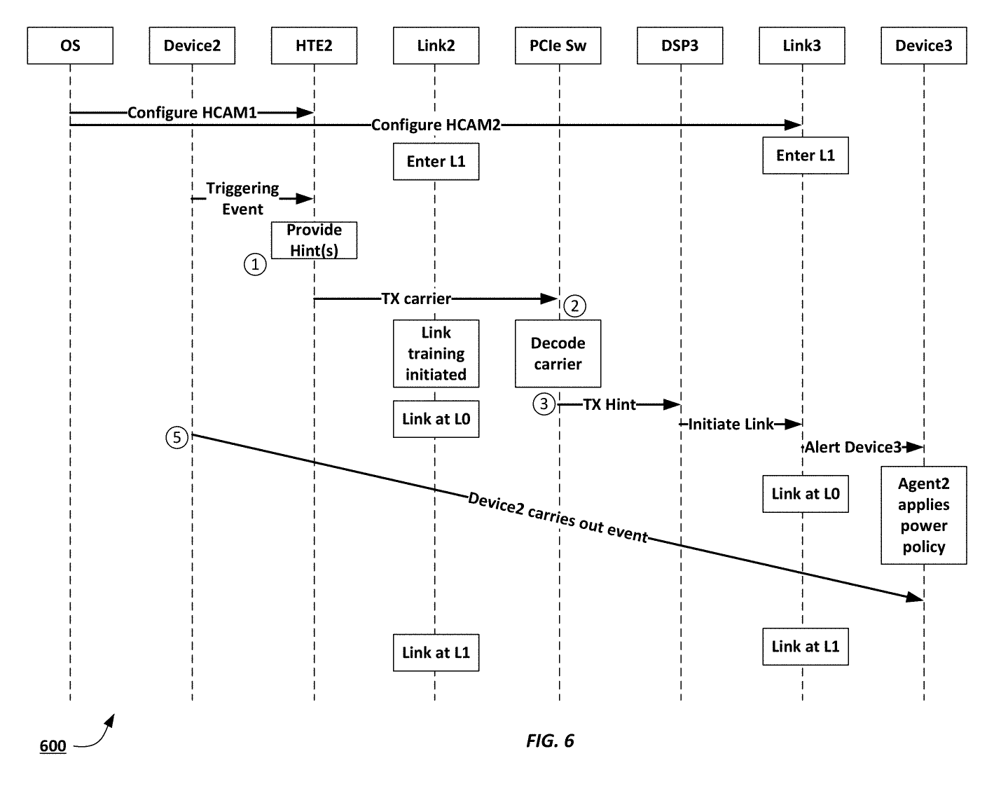

FIG. 6 is a swim lane diagram 600 illustrating a process flow for the use of hints for peer-to-peer in-band transactions in accordance with embodiments of the present disclosure. The swim lane diagram 600 can be viewed with the corresponding system 500. The swim lane diagram provides an example flow for passing hints in a PCIe Switch for Peer-to-Peer or Multicast data transportation. PCIe switch 504 is configured for Peer-to-Peer transmissions, and Device2 522 and Device3 524 each include an HTE, as described above.

At the outset, and similar to the diagram shown in FIG. 4, the system OS can configure the HCAM, optionally. When the whole hierarchy is idling for long enough, every link will be settled down in ASPM L1(given ASPM L1 is enabled through the system). Subsequently, if a Peer-to-Peer traffic is to be initiated by Device2 to Device3, then following process flow can be followed and can illustrate the benefit of the proposed In-band mechanism:

(1) A triggering event (such as a data transaction) at Device2 can cause Device2 to send TS1 OS in its Recovery.RcvrLock LTSSM substate, with the N_FTS symbol overloaded by a pre-defined hint value. The hint value can alert the Switch 504 that “a Peer-to-Peer request will be arriving and it is targeting Device3.” Link training can be initiated by the TS1 OS at link2 232.

(2) The Switch 504 can extract the N_FTS value sent by Device2 in TS1 OS, and can decode the N_FTS value to determine the hint for the Device2 event using the HTE 518.

(3) The Switch 504 (or by the HTE 518) can pass the early hint to Downstream Port 3 (DSP3) 514. In some embodiments, the Switch 504 can transmit the N_FTS in a TS1 OS directly to the DSP3 514, which can trigger link training in Link3 534. The receiving Device3 can use a local HTE to decode the N_FTS from the TS1 OS.

(4) DPS3 514 starts waking up Link3 534 by sending TS1 OS to Device3 524, with possible additional hint “telling” Device3 524 that “Device2 will be sending you Peer-to-Peer request.” The local agent at Device3 524 can apply whatever power policy is appropriate to respond to the P2P early hint.

(5) During steps 2-4, when the Link2 532 is in L0, Device2 522 starts sending the Peer-to-Peer mainstream TLP(s). Subsequently, after Link3 534 enters L0, Device3 524 will receive the Peer-to-Peer TLP(s).

At some point after the P2P transaction is complete, the devices/agents can return to L1.

The latency improvement is achieved essentially by having both Link2 532 and Link3 534 overlap their respective link training phases instead of them having link training in a serial manner. Note that the process of N_FTS versus hint extraction can be as fast as several functional clock cycles.

For simplification, the use case illustrated has an assumption that “ACS P2P Request/Completion Redirect” is not enabled. ACS is the PCIe Access Control Services, which defines a set of control points within a PCIe topology to determine whether a transaction layer packet (TLP) should be routed normally, blocked, or redirected. Yet if these features were enabled, the proposal would benefit the system even more regarding latency improvement, since the Link3 534 would be woken up even later without the proposal, because the TLPs would be redirected to Host 502 before arriving DSP3 514 to wake up the Link3 534 in traditional process.

Regardless, the USP 508 Link0 506 will be woken up within 1 [symbol] s after step 1) starts per PCIe specification regarding ASPM L1 exiting requirement. But this wake-up will not impact the latency reduction or the power saving benefits associated with the P2P transaction.

The implementation of In-band techniques are not limited to the illustrated N_FTS-based mechanism or use cases mentioned above. For example, other reserved fields in TS1 OS may be used to carry the early hints as well. In addition, with the In-band nature, the techniques described herein can be deployed through all PCIe systems and are not limited to specific form-factors.

FIG. 7 is a schematic diagram illustrating a system 700 for using hints in out-of-band transactions in accordance with embodiments of the present disclosure. The system 700 is shown to include Device1 704 that includes one or more agents, Agent1_1 712 and Agent2_1 714, at the application layer 710. Device1 704 also includes a PCIe stack 750, which is similar to that described above in FIGS. 2-3, and elsewhere. Device1 also includes an HTE 716 that can include TX and RX HCAMS.

Device1 704 can be connected to Device2 706 across a link 708. Link 708 can be a multi-lane link that is based on a PCIe protocol. Device2 706 includes one or more agents, Agent1_2 726 and Agent2_2 728, at the application layer 730. Device2 706 also includes a PCIe stack 752, which is similar to that described above in FIGS. 2-3, and elsewhere. Device2 also includes an HTE 732 that can include TX and RX HCAMS.

Similar to In-band techniques and structure, the Out-of-Band techniques are to convey early hints between devices so that necessary entities in the system can get themselves ready early in certain use cases. In Out-of-Band techniques and structures, however, an Out-of-band hint interface 760 is deployed to convey the hints between devices across the system. Therefore, secure encryptions or more timing optimization across the system could be achieved using this Out-of-band method. For example, a Host CPU running certain OS could schedule early hint to certain device at software level, which is higher than the HW application layer. This way, the targeting devices can receive hints much earlier. In addition, compared with the In-band method, another advantage of Out-of-Band method is that there are more implementation options, since it is not limited to any PCIe In-band definitions.

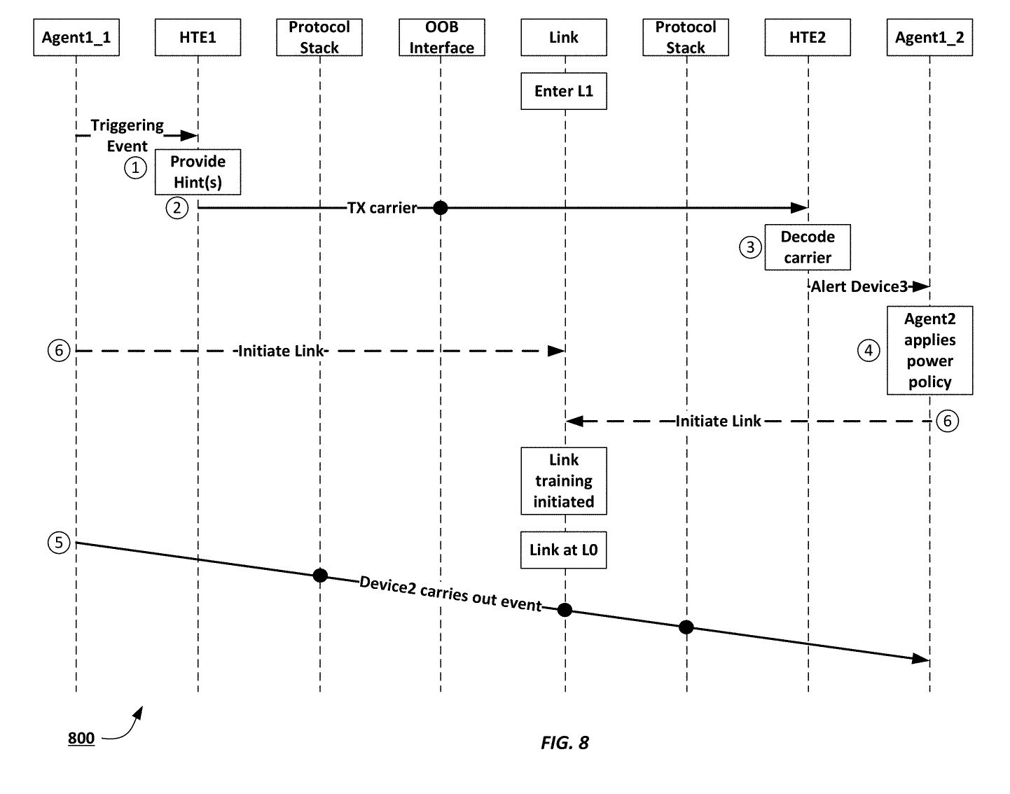

FIG. 8 is a swim lane diagram 800 illustrating the use of hints for out-of-band transactions in accordance with embodiments of the present disclosure. FIG. 8 can be viewed in the context of the structure illustrated in FIG. 7.

(1) At the outset, after the HCAMs are optionally configured, a triggering event can cause Agent1_1 712 to use the TX HCAM mapping at HTE1 716 to identify a hint carrier (e.g., N_FTS) corresponding to a hint associated with the event.

(2) The hint carrier can be transmitted across the HTE interface 760 to HTE2 732 for Device2 706.

(3) Agent2_1 726 can use the RX HCAM at HTE 732 to decode the carrier and process the hint.

(4) Agent2_1 726 can the apply power policies to prepare for the impending event from Agent1_1.

(5) Agent1_1 712 can execute the event, such as the data transaction across link 708 to Agent1_2 726.

(6) In some embodiments, Agent1_1 712 can initiate link training to L0 by transmitting TS1 OS in due course for the event. In some embodiments, Agent2_1 726 can cause link 708 to undergo link training to L0 due to having received the hint.

]: For the out-of-band implementation illustrated in FIGS. 7-8, since the mechanism to communicate hints does not depend on the multi-lane link, link training can be initiated as per the operating procedures defined by the link protocol (e.g., PCIe for a PCIe-based link).

For example, per the PCIe specification, when the link is settled in L1 state, either link partner can initiate the link training by sending electric idle exit OS (EIEOS) (when necessary) and TS1 OS via the link. In general, if a linked component needs the link to transport any TLP, the linked component can initiate the link training process to get the link to L0.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

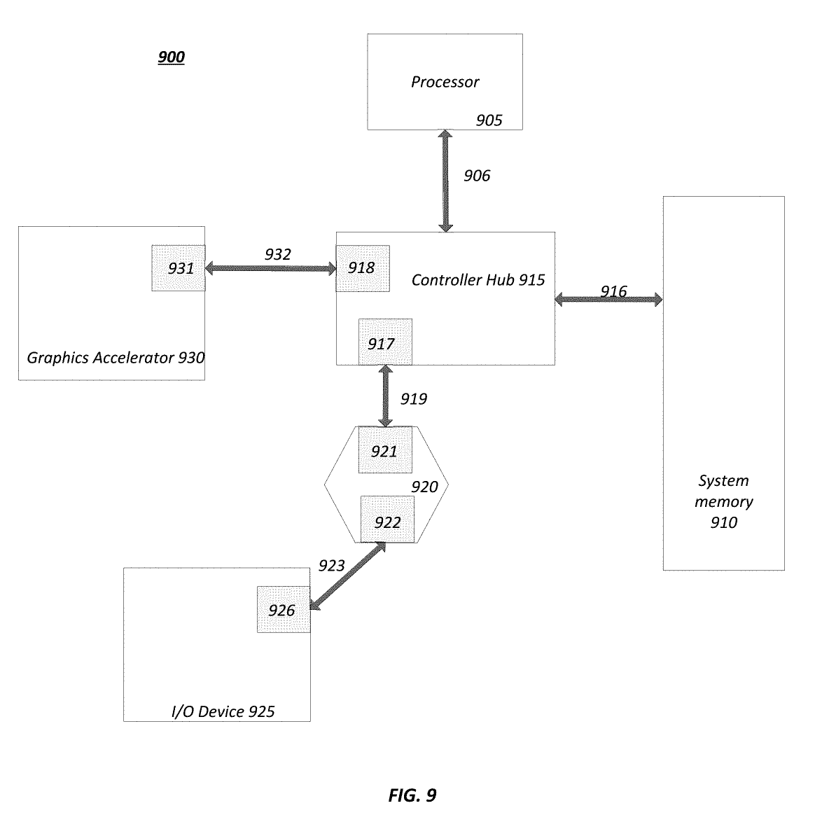

Referring to FIG. 9, an embodiment of a fabric composed of point-to-point Links that interconnect a set of components is illustrated. System 900 includes processor 905 and system memory 910 coupled to controller hub 915. Processor 905 includes any processing element, such as a microprocessor, a host processor, an embedded processor, a co-processor, or other processor. Processor 905 is coupled to controller hub 915 through front-side bus (FSB) 906. In one embodiment, FSB 906 is a serial point-to-point interconnect as described below. In another embodiment, link 906 includes a serial, differential interconnect architecture that is compliant with different interconnect standard.

System memory 910 includes any memory device, such as random access memory (RAM), non-volatile (NV) memory, or other memory accessible by devices in system 900. System memory 910 is coupled to controller hub 915 through memory interface 916. Examples of a memory interface include a double-data rate (DDR) memory interface, a dual-channel DDR memory interface, and a dynamic RAM (DRAM) memory interface.

In one embodiment, controller hub 915 is a root hub, root complex, or root controller in a Peripheral Component Interconnect Express (PCIe or PCIE) interconnection hierarchy. Examples of controller hub 915 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 905, while controller 915 is to communicate with I/O devices, in a similar manner as described below. In some embodiments, peer-to-peer routing is optionally supported through root complex 915.

Here, controller hub 915 is coupled to switch/bridge 920 through serial link 919. Input/output modules 917 and 921, which may also be referred to as interfaces/ports 917 and 921, include/implement a layered protocol stack to provide communication between controller hub 915 and switch 920. In one embodiment, multiple devices are capable of being coupled to switch 920.

Switch/bridge 920 routes packets/messages from device 925 upstream, i.e. up a hierarchy towards a root complex, to controller hub 915 and downstream, i.e. down a hierarchy away from a root controller, from processor 905 or system memory 910 to device 925. Switch 920, in one embodiment, is referred to as a logical assembly of multiple virtual PCI-to-PCI bridge devices. Device 925 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 925 may include a PCIe to PCl/PCI-X bridge to support legacy or other version PCI devices. Endpoint devices in PCIe are often classified as legacy, PCIe, or root complex integrated endpoints.

Graphics accelerator 930 is also coupled to controller hub 915 through serial link 932. In one embodiment, graphics accelerator 930 is coupled to an MCH, which is coupled to an ICH. Switch 920, and accordingly I/O device 925, is then coupled to the ICH. I/O modules 931 and 918 are also to implement a layered protocol stack to communicate between graphics accelerator 930 and controller hub 915. Similar to the MCH discussion above, a graphics controller or the graphics accelerator 930 itself may be integrated in processor 905.

Turning to FIG. 10 an embodiment of a layered protocol stack is illustrated. Layered protocol stack 1000 includes any form of a layered communication stack, such as a Quick Path Interconnect (QPI) stack, a PCie stack, a next generation high performance computing interconnect stack, or other layered stack. Although the discussion immediately below in reference to FIGS. 9-12 are in relation to a PCIe stack, the same concepts may be applied to other interconnect stacks. In one embodiment, protocol stack 1000 is a PCIe protocol stack including transaction layer 1005, link layer 1010, and physical layer 1020. An interface, such as interfaces 917, 918, 921, 922, 926, and 931 in FIG. 1, may be represented as communication protocol stack 1000. Representation as a communication protocol stack may also be referred to as a module or interface implementing/including a protocol stack.

PCI Express uses packets to communicate information between components. Packets are formed in the Transaction Layer 1005 and Data Link Layer 1010 to carry the information from the transmitting component to the receiving component. As the transmitted packets flow through the other layers, they are extended with additional information necessary to handle packets at those layers. At the receiving side the reverse process occurs and packets get transformed from their Physical Layer 1020 representation to the Data Link Layer 1010 representation and finally (for Transaction Layer Packets) to the form that can be processed by the Transaction Layer 1005 of the receiving device.

Transaction Layer

In one embodiment, transaction layer 1005 is to provide an interface between a device's processing core and the interconnect architecture, such as data link layer 1010 and physical layer 1020. In this regard, a primary responsibility of the transaction layer 1005 is the assembly and disassembly of packets (i.e., transaction layer packets, or TLPs). The translation layer 1005 typcially manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 1005. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 1005 assembles packet header/payload 1006. Format for current packet headers/payloads may be found in the PCIe specification at the PCIe specification website.

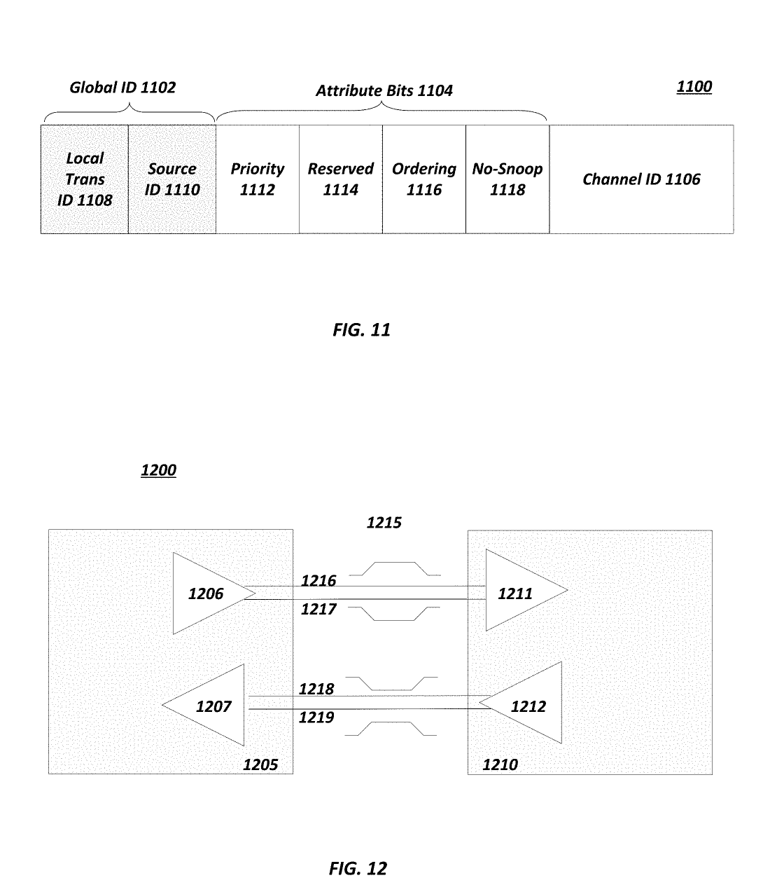

Quickly referring to FIG. 11, an embodiment of a PCIe transaction descriptor is illustrated. In one embodiment, transaction descriptor 1100 is a mechanism for carrying transaction information. In this regard, transaction descriptor 1100 supports identification of transactions in a system. Other potential uses include tracking modifications of default transaction ordering and association of transaction with channels.

Transaction descriptor 1100 includes global identifier field 1102, attributes field 1104 and channel identifier field 1106. In the illustrated example, global identifier field 1102 is depicted comprising local transaction identifier field 1108 and source identifier field 1110. In one embodiment, global transaction identifier 1102 is unique for all outstanding requests.

According to one implementation, local transaction identifier field 1108 is a field generated by a requesting agent, and it is unique for all outstanding requests that require a completion for that requesting agent. Furthermore, in this example, source identifier 1110 uniquely identifies the requestor agent within a PCIe hierarchy. Accordingly, together with source ID 1110, local transaction identifier 1108 field provides global identification of a transaction within a hierarchy domain.

Attributes field 1104 specifies characteristics and relationships of the transaction. In this regard, attributes field 1104 is potentially used to provide additional information that allows modification of the default handling of transactions. In one embodiment, attributes field 1104 includes priority field 1112, reserved field 1114, ordering field 1116, and no-snoop field 1118. Here, priority sub-field 1112 may be modified by an initiator to assign a priority to the transaction. Reserved attribute field 1114 is left reserved for future, or vendor-defined usage. Possible usage models using priority or security attributes may be implemented using the reserved attribute field.

In this example, ordering attribute field 1116 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 1118 is utilized to determine if transactions are snooped. As shown, channel ID Field 1106 identifies a channel that a transaction is associated with.

Link Layer

Link layer 1010, also referred to as data link layer 1010, acts as an intermediate stage between transaction layer 1005 and the physical layer 1020. In one embodiment, a responsibility of the data link layer 1010 is providing a reliable mechanism for exchanging Transaction Layer Packets (TLPs) between two components a link. One side of the Data Link Layer 1010 accepts TLPs assembled by the Transaction Layer 1005, applies packet sequence identifier 1011, i.e. an identification number or packet number, calculates and applies an error detection code, i.e. CRC 1012, and submits the modified TLPs to the Physical Layer 1020 for transmission across a physical to an external device.

Physical Layer

In one embodiment, physical layer 1020 includes logical sub block 1021 and electrical sub-block 1022 to physically transmit a packet to an external device. Here, logical sub-block 1021 is responsible for the “digital” functions of Physical Layer 1021. In this regard, the logical sub-block includes a transmit section to prepare outgoing information for transmission by physical sub-block 1022, and a receiver section to identify and prepare received information before passing it to the Link Layer 1010.

Physical block 1022 includes a transmitter and a receiver. The transmitter is supplied by logical sub-block 1021 with symbols, which the transmitter serializes and transmits onto to an external device. The receiver is supplied with serialized symbols from an external device and transforms the received signals into a bit-stream. The bit-stream is de-serialized and supplied to logical sub-block 1021. In one embodiment, an 8b/10b transmission code is employed, where ten-bit symbols are transmitted/received. Here, special symbols are used to frame a packet with frames 1023. In addition, in one example, the receiver also provides a symbol clock recovered from the incoming serial stream.

As stated above, although transaction layer 1005, link layer 1010, and physical layer 1020 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 12, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 1206/1211 and a receive pair 1212/1207. Accordingly, device 1205 includes transmission logic 1206 to transmit data to device 1210 and receiving logic 1207 to receive data from device 1210. In other words, two transmitting paths, i.e. paths 1216 and 1217, and two receiving paths, i.e. paths 1218 and 1219, are included in a PCIe link.

A transmission path refers to any path for transmitting data, such as a transmission line, a copper line, an optical line, a wireless communication channel, an infrared communication link, or other communication path. A connection between two devices, such as device 1205 and device 1210, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

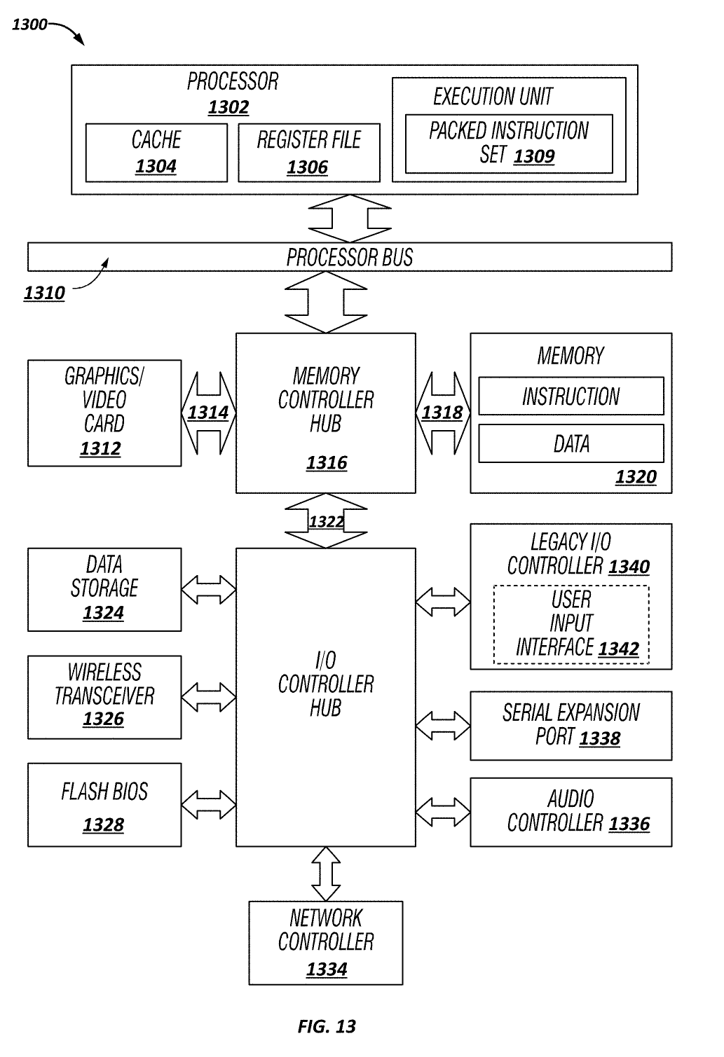

Turning to FIG. 13, a block diagram of an exemplary computer system formed with a processor that includes execution units to execute an instruction, where one or more of the interconnects implement one or more features in accordance with one embodiment of the present invention is illustrated. System 1300 includes a component, such as a processor 1302 to employ execution units including logic to perform algorithms for process data, in accordance with the present invention, such as in the embodiment described herein. System 1300 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 1300 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 1302 includes one or more execution units 1308 to implement an algorithm that is to perform at least one instruction. One embodiment may be described in the context of a single processor desktop or server system, but alternative embodiments may be included in a multiprocessor system. System 1300 is an example of a ‘hub’ system architecture. The computer system 1300 includes a processor 1302 to process data signals. The processor 1302, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 1302 is coupled to a processor bus 1310 that transmits data signals between the processor 1302 and other components in the system 1300. The elements of system 1300 (e.g. graphics accelerator 1312, memory controller hub 1316, memory 1320, I/O controller hub 1324, wireless transceiver 1326, Flash BIOS 1328, Network controller 1334, Audio controller 1336, Serial expansion port 1338, I/O controller 1340, etc.) perform their conventional functions that are well known to those familiar with the art.

In one embodiment, the processor 1302 includes a Level 1 (L1) internal cache memory 1304. Depending on the architecture, the processor 1302 may have a single internal cache or multiple levels of internal caches. Other embodiments include a combination of both internal and external caches depending on the particular implementation and needs. Register file 1306 is to store different types of data in various registers including integer registers, floating point registers, vector registers, banked registers, shadow registers, checkpoint registers, status registers, and instruction pointer register.

Execution unit 1308, including logic to perform integer and floating point operations, also resides in the processor 1302. The processor 1302, in one embodiment, includes a microcode (ucode) ROM to store microcode, which when executed, is to perform algorithms for certain macroinstructions or handle complex scenarios. Here, microcode is potentially updateable to handle logic bugs/fixes for processor 1302. For one embodiment, execution unit 1308 includes logic to handle a packed instruction set 1309. By including the packed instruction set 1309 in the instruction set of a general-purpose processor 1302, along with associated circuitry to execute the instructions, the operations used by many multimedia applications may be performed using packed data in a general-purpose processor 1302. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 1308 may also be used in micro controllers, embedded processors, graphics devices, DSPs, and other types of logic circuits. System 1300 includes a memory 1320. Memory 1320 includes a dynamic random access memory (DRAM) device, a static random access memory (SRAM) device, flash memory device, or other memory device. Memory 1320 stores instructions and/or data represented by data signals that are to be executed by the processor 1302.

Note that any of the aforementioned features or aspects of the invention may be utilized on one or more interconnect illustrated in FIG. 13. For example, an on-die interconnect (ODI), which is not shown, for coupling internal units of processor 1302 implements one or more aspects of the invention described above. Or the invention is associated with a processor bus 1310 (e.g. Intel Quick Path Interconnect (QPI) or other known high performance computing interconnect), a high bandwidth memory path 1318 to memory 1320, a point-to-point link to graphics accelerator 1312 (e.g. a Peripheral Component Interconnect express (PCIe) compliant fabric), a controller hub interconnect 1322, an I/O or other interconnect (e.g. USB, PCI, PCIe) for coupling the other illustrated components. Some examples of such components include the audio controller 1336, firmware hub (flash BIOS) 1328, wireless transceiver 1326, data storage 1324, legacy I/O controller 1310 containing user input and keyboard interfaces 1342, a serial expansion port 1338 such as Universal Serial Bus (USB), and a network controller 1334. The data storage device 1324 can comprise a hard disk drive, a floppy disk drive, a CD-ROM device, a flash memory device, or other mass storage device.

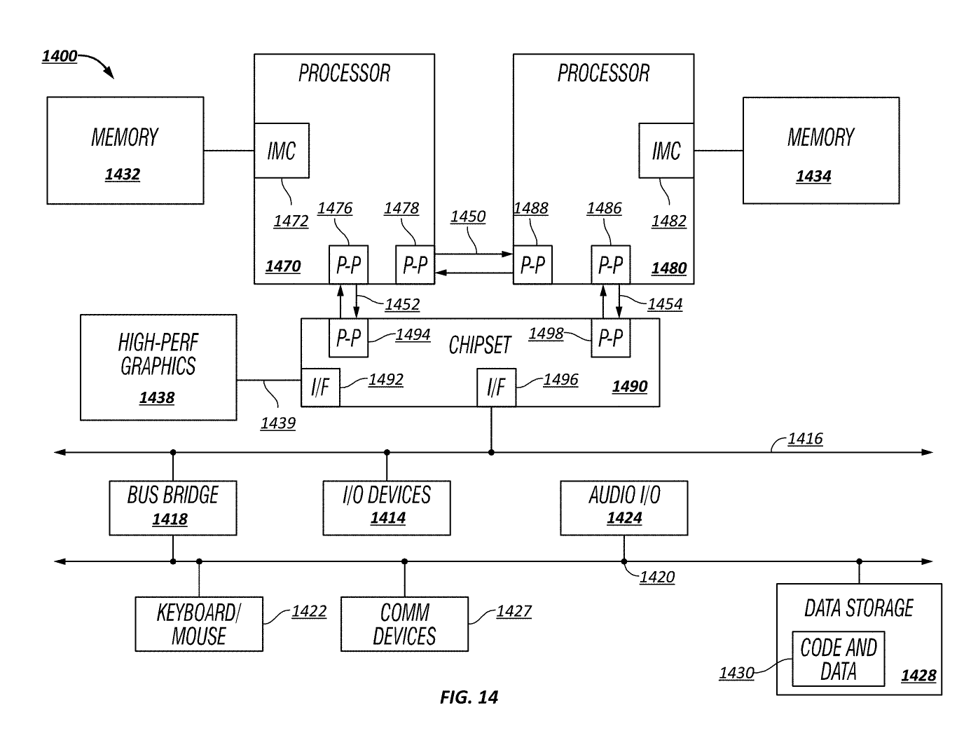

Referring now to FIG. 14, shown is a block diagram of a second system 1400 in accordance with an embodiment of the present invention. As shown in FIG. 14, multiprocessor system 1400 is a point-to-point interconnect system, and includes a first processor 1470 and a second processor 1480 coupled via a point-to-point interconnect 1450. Each of processors 1470 and 1480 may be some version of a processor. In one embodiment, 1452 and 1454 are part of a serial, point-to-point coherent interconnect fabric, such as Intel's Quick Path Interconnect (QPI) architecture. As a result, the invention may be implemented within the QPI architecture.

While shown with only two processors 1470, 1480, it is to be understood that the scope of the present invention is not so limited. In other embodiments, one or more additional processors may be present in a given processor.

Processors 1470 and 1480 are shown including integrated memory controller units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14, IMCs 1472 and 1482 couple the processors to respective memories, namely a memory 1432 and a memory 1434, which may be portions of main memory locally attached to the respective processors.

Processors 1470, 1480 each exchange information with a chipset 1490 via individual P-P interfaces 1452, 1454 using point to point interface circuits 1476, 1494, 1486, 1498. Chipset 1490 also exchanges information with a high-performance graphics circuit 1438 via an interface circuit 1492 along a high-performance graphics interconnect 1439.

A shared cache (not shown) may be included in either processor or outside of both processors; yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present invention is not so limited.

As shown in FIG. 14, various I/O devices 1414 are coupled to first bus 1416, along with a bus bridge 1418 which couples first bus 1416 to a second bus 1420. In one embodiment, second bus 1420 includes a low pin count (LPC) bus. Various devices are coupled to second bus 1420 including, for example, a keyboard and/or mouse 1422, communication devices 1427 and a storage unit 1428 such as a disk drive or other mass storage device which often includes instructions/code and data 1430, in one embodiment. Further, an audio I/O 1424 is shown coupled to second bus 1420. Note that other architectures are possible, where the included components and interconnect architectures vary. For example, instead of the point-to-point architecture of FIG. 14, a system may implement a multi-drop bus or other such architecture.

FIG. 15 is a schematic diagram illustrating a Link Training and Status State Machine for Recovery in accordance with embodiments of the present disclosure. Based on the PCI Express Base Specification, if the In-band method described above is employed using N_FTS to convey hints in TS1 OS during Recovery.RcvrLock substate, the early hint is received before the receiving device LTSSM enters Recovery.RcvrCfg substate. Therefore, at least the time spent on Recovery.RcvrCfg and Recovery.Idle is saved for the receiving device to get the hint. Otherwise, in order to figure out the precise response to the link_training event, the device would have to wait until L0 state is entered and the first TLP is received. Based on PCIe SPEC, time needed for Recovery.RcvrCfg and Recovery.Idle in total is listed in Table 1.

TABLE 1
Minimum latency improvement benefit

| | Latency reduced for the receiving | |
|---|---|---|
| PCIe Speed | device to react precisely | |
| Gen1 (2.5 GHz) | 512 | ns |
| Gen 2 (5 GHz) | 256 | ns |
| Gen 3 (8 GHz) | 138 | ns |
| Gen 4 (16 GHz) | 69 | ns |
| Gen 5 (32 GHz) | 34.5 | ns |

The PCI Express Base Specification provides an excerpt of the definition. Table 2 is the excerpt for of the N_FTS definition:

TABLE 2
PCIe definition of TS1/TS2 OS (excerpt)

| Symbol | |
|---|---|
| Number | Description |
| 0 | When operating at 2.5 or 5.0 GT/s: COM (K28.5) for Symbol |
| | alignment. |
| 1 | When operating at 8.0 GT/s or above: Encoded as 1Eh (TS1 |
| | OS). |
| 2 | Link Number. |
| | Ports that do not support 8.0 GT/s or above: 0-255, PAD. |
| | Downstream Ports that support 8.0 GT/s or above: 0-31, PAD. |
| | Upstream ports that support 8.0 GT/s or above: 0-255, PAD. |
| | When operating at 2.5 or 5.0 GT/s: PAD is encoded as K23.7. |
| | When operating at 8.0 GT/s or above: PAD is encoded as F7h. |
| 3 | N_FTS. The number of Fast Training Sequences required by |
| | the Receiver: 0-255 |

While this disclosure has been described with respect to a limited number of embodiments, those skilled in the art will appreciate numerous modifications and variations therefrom. It is intended that the appended claims cover all such modifications and variations as fall within the true spirit and scope of this present disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase “to” or “configured to,” in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

The systems, methods, and apparatuses can include one or a combination of the following examples:

Example is 1 an apparatus comprising an application layer logic implemented at least partially in hardware circuitry; a first port for transmitting information across a multi-lane link, the first port comprising a protocol stack; a memory element, the memory element comprising mapping between an event identifier value and an event identifier carrier value, the event identifier identifying an event to be carried out by the application layer logic across the multi-lane link—the event identifier carrier value mapped to the event identifier, the application layer logic to transmit the event identifier carrier value across the link prior to executing the event.

Example 2 may include the subject matter of example 1, wherein the event identifier carrier value comprises a number of fast training sequence (N_FTS) value, the N_FTS value corresponding to an event to be carried out by the application layer logic.

Example 3 may include the subject matter of example 1, wherein the apparatus is to encode the event identifier carrier value in a reserved field in a training symbol 1 ordered set (TS1 OS).

Example 4 may include the subject matter of any of examples 1-3, wherein the application layer logic is to transmit the event identifier carrier value using a training symbol 1 ordered set (TS1 OS) across a physical layer of a protocol stack across the link.

Example 5 may include the subject matter of example 4,wherein the link comprises a L1 power substate, and wherein the TS1 OS triggers link training for the link to enter into an L0 state.

Example 6 may include the subject matter of any of examples 1-5, wherein the memory element is configured by an operating system or host driver to map event identifier values with event identifier carrier values.

Example 7 may include the subject matter of any of examples 1-3 and 5-6, further comprising an interface separate from the link for transmission of the event identifier value to another apparatus.

Example 8 may include the subject matter of any of examples 1-7, wherein the memory element comprises a transmission (TX) hint context addressable memory that includes a mapping between event identifier values to event carrier identifier carrier values and a reception (RX) hint context addressable memory that includes a mapping for received event identifier carrier values to identify event identifier values.

Example 9 may include the subject matter of any of examples 1-8, wherein the application layer logic comprises a system agent, the system agent to trigger or respond to events and to cause the identification of event identifier carrier values based on an event and to transmit the event identifier carrier values across the link or across a dedicated event identifier carrier value interface.

Example 10 may include the subject matter of any of examples 1-9, wherein the link and the protocol stack are compliant with a Peripheral Component Interconnect Express (PCIe)-based protocol.

Example 11 is a computer-implemented method comprising identifying an early hint value associated with a triggering event; identifying, from a hint context addressable memory, a hint carrier value mapped to the early hint; transmitting the hint carrier across one of a multi-lane link or a dedicated hint carrier interface.

Example 12 may include the subject matter of example 11, wherein the hint carrier value comprises a number of fast training sequence (N_FTS) value, the N_FTS value corresponding to the early hint associated with the triggering event.

Example 13 may include the subject matter of example 11, the method comprising encoding the hint carrier value into a reserved field of a TS1 OS.

Example 14 may include the subject matter of any of examples 11-13, further comprising transmitting the hint carrier value using a training symbol 1 ordered set (TS1 OS) across one of a physical layer of a protocol stack across the link or a dedicated interface.

Example 15 may include the subject matter of example 14, wherein transmitting the TS1 OS across the link causes the link to undergo link training from an L1 state to an L0 state.

Example 16 may include the subject matter of any of examples 11-15, the method comprising configuring the mapping between early hint values and corresponding hint carrier values based on configuration information received from an operating system or host driver.

Example 17 may include the subject matter of any of examples 11-16, further comprising executing the triggering event, wherein executing the triggering event comprises transmitting data across the link.

Example 18 is a computing system comprising a first device comprising a first hint engine (HTE), the hint engine comprising a memory element, the memory comprising mapping between an early hint value and a hint carrier value; a second device comprising a second HTE, the second HTE comprising a mapping between the hint carrier value and the early hint value; the first device connected to the second device across a multi-lane link; in response to a triggering event, the first device to identify an early hint value associated with the triggering event, identify a hint carrier value corresponding to the early hint value based on a mapping stored in the first HTE, augment a training symbol ordered set with the hint carrier value, and transmit the training symbol ordered set to the second device. Upon receiving the training symbol ordered set, the second device to determine the early hint corresponding to the hint carrier received with the training symbol ordered set; determine the triggering event based on the early hint; and implement one or more power policies to prepare for the triggering event.

Example 19 may include the subject matter of example 18, wherein the training symbol ordered set comprises a training symbol 1 ordered set (TS1 OS), and wherein first device is to transmit the TS1 OS through a physical layer of a protocol stack, the TS1 OS to initiate a link training for the multi-lane link to transition the multi-lane link from an L1 state to an L0 state.

Example 20 may include the subject matter of example 18, wherein the first device is to transmit the training symbol ordered set to the second device across a dedicated interface.

Example 21 may include the subject matter of example a system comprising a switch complex comprising a first downstream port coupled to a first multi-lane link, a second downstream port coupled to a second multi-lane link, and hint engine logic, the hint engine logic comprising a memory element that comprises a mapping between an early hint associated with a transaction event and a hint carrier, a first device coupled to the switch complex by the first multi-lane link, the first device comprising a first local hint engine logic; a second device coupled to the switch complex by the second multi-lane link, the second device comprising a second local hint engine logic. The first device to initiate a transaction event intended for the second device, encode a training symbol with a hint carrier corresponding to an early hint associated with the transaction event, and transmit the training symbol to the first downstream port of the switch complex. The switch complex to provide an indication to the second device of the transaction event. The second device to prepare for the transaction event triggered by the first device based on receiving the indication of the transaction event from the switch complex.

Example 22 may include the subject matter of example 21, wherein the switch complex is to decode the training symbol by the hint engine logic to identify the early hint associated with the transaction event; and transmit the early hint to the second device.

Example 23 may include the subject matter of example 21, wherein the switch complex is to transmit the training symbol ordered set and the hint carrier to the second device; and wherein the second device is to decode the hint carrier by the second local hint engine logic to identify the early hint associated with the transaction event; apply one or more power policies to prepare for the transaction event indicated by the early hint.

Example 24 may include the subject matter of any of examples 21-23, wherein the training symbol ordered set comprises a training symbol 1 ordered set (TS1 OS); and wherein the first local hint engine logic encodes the hint carrier in a field of the TS1 OS, the field comprising one of a number of fast training sequences (N_FTS) field or a reserved field of the TS1 OS.

Example 25 may include the subject matter of any of examples 21-24, the first device to cause the first link to undergo link training to an L0 state based on the transmission of the training symbol, and execute the transaction event after the first link reaches the L0 state. The switch complex to cause the second link to undergo link training to an L0 state based on the transmission of the indication of the transaction event, and transmit the transaction event to the second device after the second link reaches the L0 state.

Example 26 is an apparatus comprising means for mapping a hint to a transaction event to a hint carrier; means for identifying a hint carrier for a transaction event; means for encoding the a training symbol ordered set with the hint carrier; means for transmitting the training symbol ordered set to a connected device.

Example 27 is a computer program product tangibly embodied on non-transitory computer readable media, the computer program product comprising instructions, that when executed, cause a computing system to identify an early hint value associated with a triggering event; identify, from a hint context addressable memory, a hint carrier value mapped to the early hint; and transmit the hint carrier across one of a multi-lane link or a dedicated hint carrier interface.

What is claimed is:

1. An apparatus comprising:
an application layer logic implemented at least partially in hardware circuitry;
a first port for transmitting information across a multi-lane link, the first port comprising a protocol stack;
a memory element, the memory element comprising mapping between an event identifier value and an event identifier carrier value, the event identifier identifying an event to be carried out by the application layer logic across the multi-lane link—the event identifier carrier value mapped to the event identifier, the application layer logic to transmit the event identifier carrier value across the link prior to executing the event.

2. The apparatus of claim 1, wherein the event identifier carrier value comprises a number of fast training sequence (N_FTS) value, the N_FTS value corresponding to an event to be carried out by the application layer logic.

3. The apparatus of claim 1, wherein the apparatus is to encode the event identifier carrier value in a reserved field in a training symbol 1 ordered set (TS1 OS).

4. The apparatus of claim 1, wherein the application layer logic is to transmit the event identifier carrier value using a training symbol 1 ordered set (TS1 OS) across a physical layer of a protocol stack across the link.

5. The apparatus of claim 4, wherein the link comprises a L1 power substate, and wherein the TS1 OS triggers link training for the link to enter into an L0 state.

6. The apparatus of claim 1, wherein the memory element is configured by an operating system or host driver to map event identifier values with event identifier carrier values.

7. The apparatus of claim 1, further comprising an interface separate from the link for transmission of the event identifier value to another apparatus.

8. The apparatus of claim 1, wherein the memory element comprises a transmission (TX) hint context addressable memory that includes a mapping between event identifier values to event carrier identifier carrier values and a reception (RX) hint context addressable memory that includes a mapping for received event identifier carrier values to identify event identifier values.

9. The apparatus of claim 1, wherein the application layer logic comprises a system agent, the system agent to trigger or respond to events and to cause the identification of event identifier carrier values based on an event and to transmit the event identifier carrier values across the link or across a dedicated event identifier carrier value interface.

10. The apparatus of claim 1, wherein the link and the protocol stack are compliant with a Peripheral Component Interconnect Express (PCIe)-based protocol.

11. A computer-implemented method comprising:
identifying an early hint value associated with a triggering event;
identifying, from a hint context addressable memory, a hint carrier value mapped to the early hint; and
transmitting the hint carrier across one of a multi-lane link or a dedicated hint carrier interface.

12. The method of claim 11, wherein the hint carrier comprises a number of fast training sequence (N_FTS) value, the N_FTS value corresponding to the early hint associated with the triggering event.

13. The method of claim 11, further comprising encoding the hint carrier value into a reserved field of a training symbol 1 ordered set (TS1 OS).

14. The method of claim 11, further comprising transmitting the hint carrier value using a training symbol 1 ordered set (TS1 OS) across one of a physical layer of a protocol stack across the link or a dedicated interface.

15. The method of claim 14, wherein transmitting the TS1 OS across the link causes the link to undergo link training from an L1 state to an L0 state.

16. The method of claim 11, further comprising configuring the mapping between early hint values and corresponding hint carrier values based on configuration information received from an operating system or host driver.

17. The method of claim 11, further comprising executing the triggering event, wherein executing the triggering event comprises transmitting data across the link.

18. A computing system comprising:
a first device comprising:
a first hint engine (HTE), the hint engine comprising a memory element, the memory comprising mapping between an early hint value and a hint carrier value;
a second device comprising a second HTE, the second HTE comprising a mapping between the hint carrier value and the early hint value;
the first device connected to the second device across a multi-lane link;
in response to a triggering event, the first device to:
identify an early hint value associated with the triggering event,
identify a hint carrier value corresponding to the early hint value based on a mapping stored in the first HTE,
augment a training symbol ordered set with the hint carrier value, and
transmit the training symbol ordered set to the second device;
upon receiving the training symbol ordered set, the second device to:
determine the early hint corresponding to the hint carrier received with the training symbol ordered set;
determine the triggering event based on the early hint; and
implement one or more power policies to prepare for the triggering event.

19. The computing system of claim 18, wherein the training symbol ordered set comprises a training symbol 1 ordered set (TS1 OS), and wherein first device is to transmit the TS1 OS through a physical layer of a protocol stack, the TS1 OS to initiate a link training for the multi-lane link to transition the multi-lane link from an L1 state to an L0 state.

20. The computing system of claim 18, wherein the first device is to transmit the training symbol ordered set to the second device across a dedicated interface.

21. A system comprising:
a switch complex comprising:
a first downstream port coupled to a first multi-lane link,
a second downstream port coupled to a second multi-lane link, and
hint engine logic, the hint engine logic comprising a memory element that comprises a mapping between an early hint associated with a transaction event and a hint carrier,
a first device coupled to the switch complex by the first multi-lane link, the first device comprising a first local hint engine logic;
a second device coupled to the switch complex by the second multi-lane link, the second device comprising a second local hint engine logic;
the first device to:
initiate a transaction event intended for the second device,
encode a training symbol with a hint carrier corresponding to an early hint associated with the transaction event, and
transmit the training symbol to the first downstream port of the switch complex;
the switch complex to provide an indication to the second device of the transaction event;
the second device to:
prepare for the transaction event triggered by the first device based on receiving the indication of the transaction event from the switch complex.

22. The system of claim 21, wherein the switch complex is to:
decode the training symbol by the hint engine logic to identify the early hint associated with the transaction event; and
transmit the early hint to the second device.

23. The system of claim 21, wherein the switch complex is to transmit the training symbol ordered set and the hint carrier to the second device; and
wherein the second device is to:
decode the hint carrier by the second local hint engine logic to identify the early hint associated with the transaction event;
apply one or more power policies to prepare for the transaction event indicated by the early hint.

24. The system of claim 21, wherein the training symbol ordered set comprises a training symbol 1 ordered set (TS1 OS); and
wherein the first local hint engine logic encodes the hint carrier in a field of the TS1 OS, the field comprising one of a number of fast training sequences (N_FTS) field or a reserved field of the TS1 OS.

25. The system of claim 21, the first device to:
cause the first link to undergo link training to an L0 state based on the transmission of the training symbol, and
execute the transaction event after the first link reaches the L0 state; and
the switch complex to:
cause the second link to undergo link training to an L0 state based on the transmission of the indication of the transaction event, and
transmit the transaction event to the second device after the second link reaches the L0 state.
